(19) United States
(12) Patent Application Publication
(10) Pub. No.: US 2015/0079974 A1
(43) Pub. Date: Mar. 19, 2015

(54) ITERATIVE FAIR CHANNEL ASSIGNMENT IN WIRELESS SPECTRA

(71) Applicant: Fujitsu Limited, Kawasaki-shi (JP)

(72) Inventors: Golnaz Farhadi, Sunnyvale, CA (US); Karim Khalil, Columbus, OH (US); Akiro Ito, San Jose, CA (US)

(73) Assignee: Fujitsu Limited, Kawasaki-shi (JP)

(21) Appl. No.: 14/027,092

(22) Filed: Sep. 13, 2013

(51) Int. Cl. H04W 16/10; H04W 72/08

(52) U.S. Cl. CPC H04W 16/10; H04W 72/082
USPC 455/426.1

(57) ABSTRACT

A method and system for iterative fair channel assignment may orthogonally assign K channels to N wireless networks such that neighbor networks operate over different frequencies. The iterative fair channel assignment may include an orthogonal channel assignment that may not only assign a fair share of spectrum to each network but may also increase the spectrum re-use by assigning channels to as many networks as possible.

### BACKGROUND

1. Field of the Disclosure

This disclosure relates generally to communication networks and, in particular, to iterative fair channel assignment in wireless spectra.

2. Description of the Related Art

As the number and types of wireless networks proliferate, and the amount of communication carried thereon increases, it has become increasingly desirable to manage networks comprising wireless networks of differing wireless access technologies, power limitations, frequency limitations, and other differences. Management of such heterogeneous networks may become increasingly complicated due to limited availability of wireless spectrum. While some solutions have been offered for managing coexistence of different wireless networks, maximization of spectrum re-use as well as spectrum utilization while avoiding interference remains a challenge.

### SUMMARY

In one aspect, a disclosed method for iterative fair channel assignment includes receiving channel information for K wireless channels available at a location, and receiving network information for N wireless networks operating in the location, the network information describing interference between neighboring pairs of networks in the N wireless networks. The method may include, for each of the K wireless channels, including a first channel, assigning the first channel to a first network selected from the N wireless networks, and assigning the first channel to other networks selected from the N wireless networks not interfering with the first network. The first network may be preferentially selected to have a minimum weight factor. The other networks may be preferentially selected to have smaller weight factors. A weight factor for a first wireless network may indicate a measure of fairness in assigning the K wireless channels to the first wireless network. Assigning the first channel may maintain orthogonality of wireless channels assigned to each of the neighboring pairs of networks.

Additional disclosed aspects for iterative fair channel assignment include an article of manufacture comprising a non-transitory, computer-readable medium, and computer executable instructions stored on the computer-readable medium. A further aspect includes a management system for iterative fair channel assignment comprising a memory, a processor coupled to the memory, a network interface, and computer executable instructions stored on the memory.

The object and advantages of the embodiments will be realized and achieved at least by the elements, features, and combinations particularly pointed out in the claims.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram of selected elements of an embodiment of a network for iterative fair channel assignment;

FIG. 2 is a block diagram of selected elements of an embodiment of a management system for iterative fair channel assignment;

FIG. 3 is a block diagram of selected elements of an embodiment of a framework for iterative fair channel assignment;

FIG. 4 is a flow chart illustrating selected elements of an embodiment of a method for iterative fair channel assignment;

FIG. 5 is a diagram of selected elements of an embodiment of an interference graph for iterative fair channel assignment;

FIG. 6A is a diagram of selected elements of an embodiment of a prior art colored interference graph; and

FIG. 6B is a diagram of selected elements of an embodiment of an interference graph colored using iterative fair channel assignment.

### DESCRIPTION OF PARTICULAR EMBODIMENT(S)

Spectrum is a precious commodity for wireless carriers. In particular, with proliferation of mobile devices and exponential data traffic growth, the demand for spectrum has grown. However, any new additional spectrum may be too little too late given the cost and timeline for the reframing of presently allocated spectrum. On one hand, each network desirably has access to all available resources; on the other hand, when the same resource is allocated to certain networks in close proximity of each other, high levels of congestion may result, and, hence, lead to performance degradation. Growing scarcity of the available spectrum, as well as growing reliance on offloading data traffic over unlicensed bands (e.g., Wi-Fi networks in ISM bands and/or white space channels in the TV band) or small cells (e.g., based on LTE technology) call for an efficient channel assignment to increase spectrum utilization while avoiding interference.

Conventional graph coloring algorithms have been used for resource allocation in many applications (e.g., channel assignment in wireless networks). In general, a wireless network may be represented as a graph with networks denoted by nodes, while an edge between a pair of nodes denotes that the networks represented by the pairs of nodes interfere. Each channel may be represented by a color (or pattern) of a node, while a number of edges per node may be referred to as a ‘node degree’. Certain algorithms, referred to as greedy graph coloring algorithms, consider the nodes in a specific order and assign to each node, chosen based on the order, a smallest available color not used by neighboring networks. In certain cases, a fresh color may be added when desired or needed. The quality of the resulting coloring, in the terms of number of colors used, may depend on the type of ordering used. One type of ordering may lead to a greedy coloring with a minimum number of colors (also known as the ‘chromatic number’ of a graph). However, optimal graph coloring may be computationally difficult. Also, greedy graph coloring algorithms may be limited to an arbitrary quality for a given order, and different types of ordering heuristics have been used. Although, known greedy graph coloring algorithms may achieve orthogonal assignment (assuming enough colors exist), such algorithms may fail to increase utilization of the available channels.

As will be described in further detail herein, an iterative fair channel assignment algorithm is disclosed that allocates a fair share of available channels to each network while re-using channels in as many networks as possible. The iterative fair channel assignment algorithm disclosed herein may also capitalize on a capability of various existing and/or newer wireless access technologies to aggregate/bond channels to increase spectrum utilization by assigning each network more than one channel whenever possible.

In the following description, details are set forth by way of example to facilitate discussion of the disclosed subject matter. It should be apparent to a person of ordinary skill in the field, however, that the disclosed embodiments are exemplary and not exhaustive of all possible embodiments.

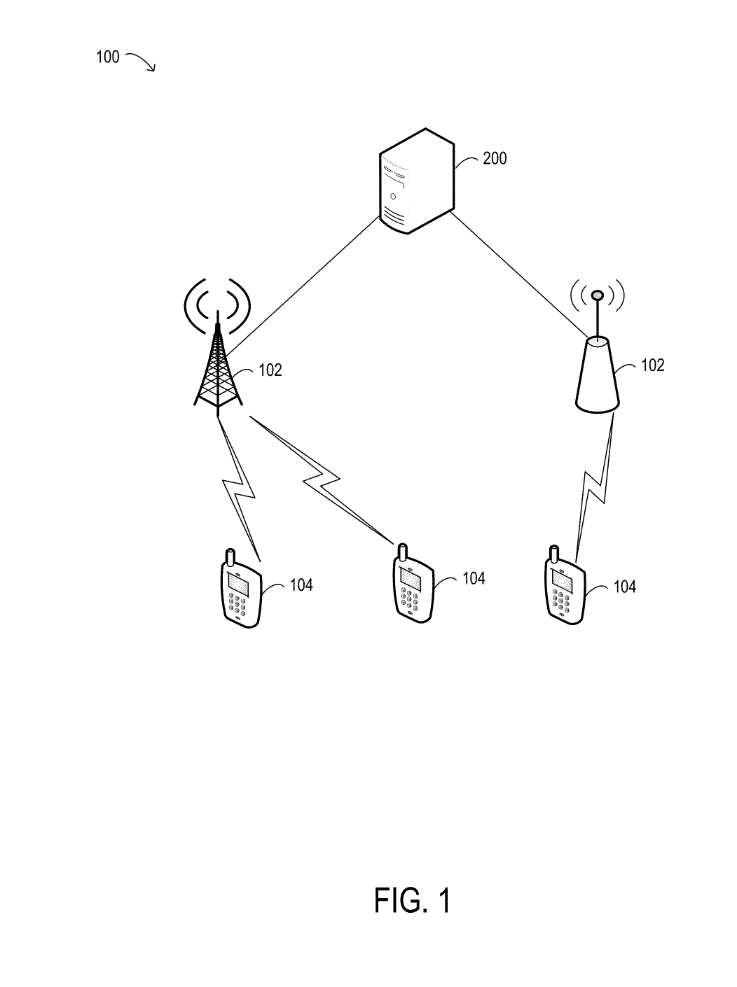

Particular embodiments and their advantages are best understood by reference to FIGS. 1 through 6B, wherein like numbers are used to indicate like and corresponding parts.

Turning now to the drawings, FIG. 1 is a block diagram showing selected elements of an embodiment of network 100 for iterative fair channel assignment, in accordance with certain embodiments of the present disclosure. In some embodiments, network 100 may include wireless networks 102, user equipment 104, and management system 200 communicatively coupled to wireless networks 102. As shown in FIG. 1, management system 200 may be in fixed communication with wireless networks 102 using galvanic and/or optical media (not shown), for example. Wireless networks 102 may, in turn, provide wireless signals for enabling network access by user equipment 104 to allow communication by user equipment 104 across wireless networks 102. As will be described herein, management system 200 may be configured to implement an iterative fair channel assignment algorithm to enable each of wireless networks 102 to increase spectrum utilization while avoiding interference.

In some embodiments, wireless network 102 may be an access point to a communication network, the access point configured to allow user equipment 102 to communicate over the communication network. In some embodiments, each wireless network 102 shares substantially the same spectrum band as other wireless networks 102, while potentially operating on a different wireless access technology (e.g., IEEE 802.11, IEEE 802.22, LTE, etc.). Further, each wireless network 102 may be owned and/or operated by a different operator. For example, system 100 may include four wireless networks 102, including two LTE transmission towers, and two 802.22 wireless access points. In the same or alternative configurations, system 100 may include, more, fewer, or different configurations of wireless networks 102 and management system 200 without departing from the scope of the present disclosure.

In some embodiments, user equipment 104 may be an electronic device and/or combination of electronic devices configured to communicate and/or facilitate communication over any or all of the wireless networks 102. For example, user equipment 104 may be a cellular telephone, tablet computer, laptop computer, network of other user equipment 104, and/or other appropriate electronic device may be configured to transmit and/or receive data over wireless network 102.

In operation, network 100 may be located in an area with N wireless networks 102. Such a topology may be represented by a graph, G, with N nodes (each network being represented by a node), and E edges. If networks i and j are in the interference range of each other, there is an edge e between i and j in the graph, given by e_{ij}=1. Also, it may be assumed that K channels are available to the N wireless networks, which may be channels in so-called industrial, scientific, and medical (ISM) bands and/or channels in white space television bands and/or channels in another band. Each channel may be associated with a bandwidth w (in MHz). A primary goal is for channel assignment may be to assign the K channels to the N wireless networks, such that neighbor networks are assigned different channels, which may be represented by a proper graph coloring in which neighboring nodes have different colors. In graph coloring, the quality of an algorithm may be assessed based on a minimum number of colors used to color a graph. However, it may be difficult to compute a chromatic number for more complicated graphs, and may represent a non-deterministic polynomial-time (NP) hard problem. As noted previously, conventional greedy coloring algorithms depend on an order in which the nodes are colored (i.e., an ordering of the graph) and, thus, may not achieve an optimal and/or desired coloring result, for example, in terms of a minimum number of colors used. However, it has been shown that the chromatic number, χ, may have an upper bounded, given by Formula [1].

χ≦∂+1 Formula [1]

In Formula [1], a denotes the maximum node degree. Therefore, with K colors (representing channels) larger than ∂+1, each network gets at least one color using any arbitrary ordering of the graph nodes.

In the present disclosure, it is assumed that the available number of channels meets the upper bound of ∂+1. Furthermore, the methods and algorithms disclosed herein re-use the available channels in as many networks as possible and may allocate more than one channel to a node while maintaining a fair allocation across networks. When the actual chromatic number χ of a graph is smaller than or equal to K, the methods and algorithms disclosed herein may achieve an improved spectrum utilization compared to conventional greedy graph coloring algorithms using a given ordering of the networks. Furthermore, the methods and algorithms disclosed herein may be extended to cases where the available number of channels is not sufficient for completely orthogonal channel allocation for all networks. In such instances, a network having a maximum node degree in the interference graph is considered and an edge with a farthest neighbor of such a network may be removed (i.e., the same channel may be assigned to a farthest network with a weakest level of interference). This procedure may be repeated until a number of available channels is sufficient for orthogonal channel assignment.

As disclosed herein, methods and algorithms for iterative fair channel assignment are presented that assign orthogonal channels while achieving a fair allocation and increasing utilization of the available spectrum. In one embodiment, a first algorithm is disclosed that assigns channels to networks starting from networks with a smaller weight factor, w_f, and re-uses the same channel in as many networks as possible, giving higher priority to networks with smaller weight factors. The first algorithm may break ties randomly when multiple networks have the same weight factor. In some embodiments, a second algorithm for determining channel re-use may be used. It is noted that the weight factor w_f may reflect a measure of fairness for each network. When only location information for each network is available at a management system executing the algorithm, the weight factor w_f may be a number of channels assigned to a network. When additional information (e.g., network load) is known, the weight factor w_f may be defined such that networks with a larger load, but with a smaller number of assigned channels, may receive higher priority (e.g., the weight factor may be defined as a number of assigned channels divided by a network load).

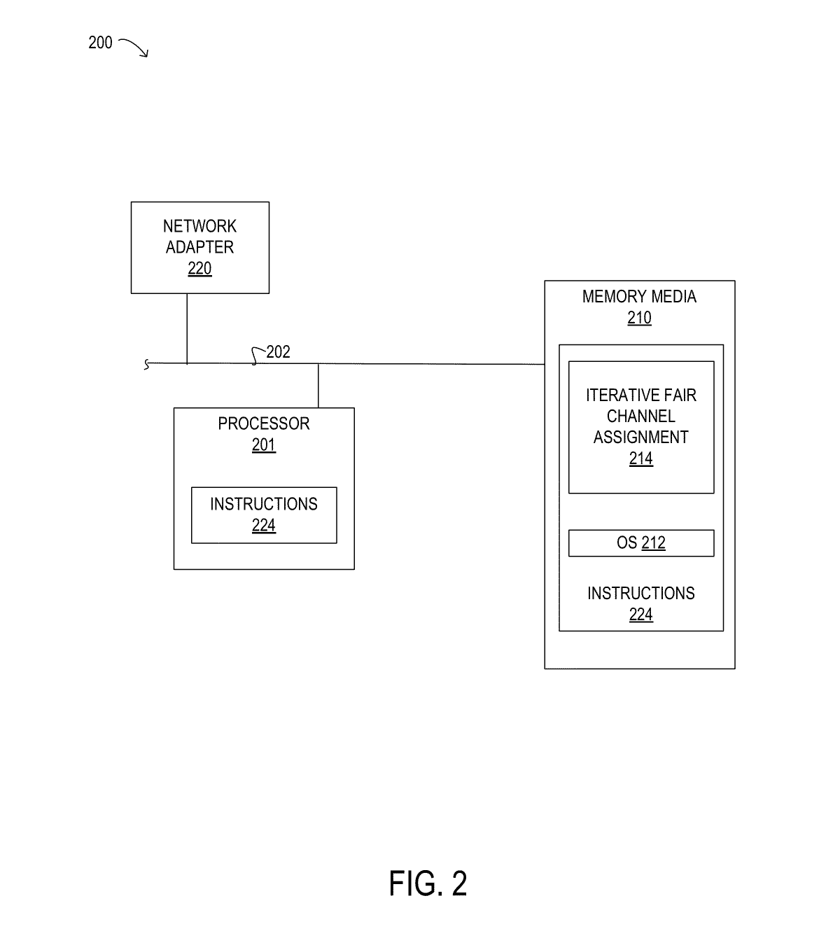

Referring now to FIG. 2, a block diagram illustrates selected elements of an embodiment of management system 200 for iterative fair channel assignment according to the present disclosure. In the embodiment depicted in FIG. 2, management system 200 includes processor 201 coupled via shared bus 202 to storage media collectively identified as memory media 210. Management system 200, as depicted in FIG. 2, further includes network adapter 220 that interfaces management system 200 to a network, such as portions of network 100, including wireless networks 102 (see FIG. 1).

In FIG. 2, memory media 210 may comprise persistent and volatile media, fixed and removable media, and magnetic and semiconductor media. Memory media 210 is operable to store instructions, data, or both. Memory media 210 as shown includes sets or sequences of instructions 224, namely, an operating system 212 and iterative fair channel assignment 214. Operating system 212 may be a UNIX or UNIX-like operating system, a Windows® family operating system, or another suitable operating system. Instructions 224 may also reside, completely or at least partially, within processor 201 during execution thereof. It is further noted that processor 201 may be configured to receive instructions 224 from memory media 210 via shared bus 202. As described herein, for iterative fair channel assignment 214 may represent instructions and/or code for implementing various algorithms according to the present disclosure.

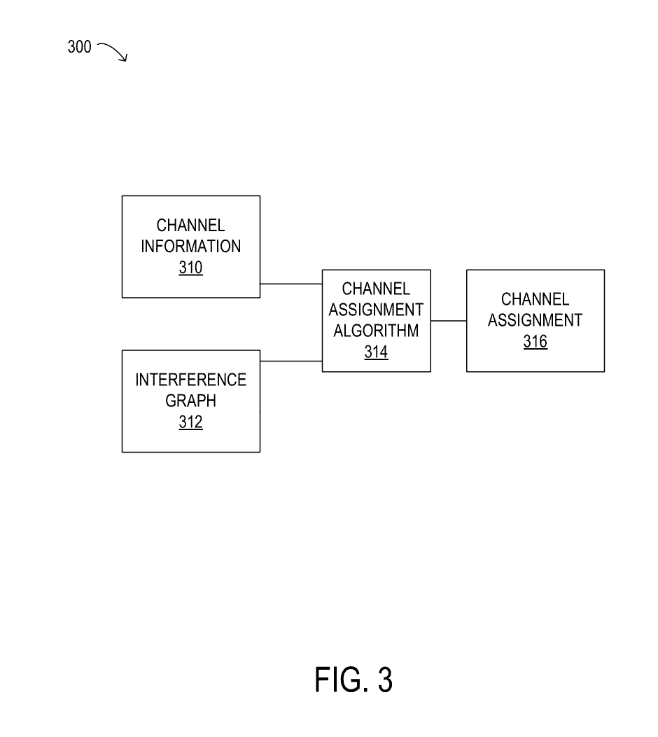

Referring now to FIG. 3, a block diagram illustrates selected elements of an embodiment of framework 300 for iterative fair channel assignment according to the present disclosure. As shown, framework 300 describes relationships between information (i.e., data) and processes involved with iterative fair channel assignment, as disclosed herein. It is noted that framework 300 may represent functionality implemented by management system 200, and in particular, iterative fair channel assignment 214 (see FIG. 2).

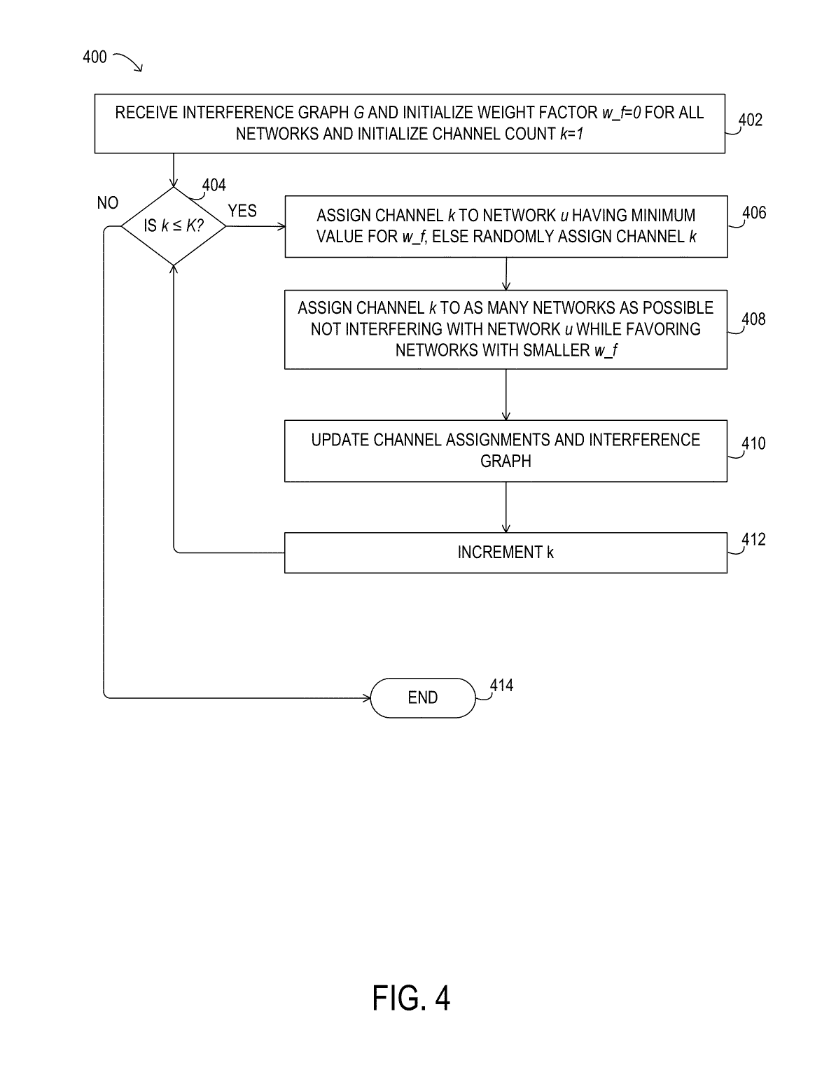

In framework 300 of FIG. 3, channel information 310 may be received for K available wireless channels at a location where N wireless networks operate. Channel information 310 may include various attributes and constraints for the K wireless channels, such as bandwidth, spectral band, power level, regulatory constraints etc. Interference graph 312 may represent a graph structure describing the N wireless networks, and may be based on location information, types of wireless networks, interference between individual networks, etc. It is noted that in some embodiments, the information for generating interference graph 312 may be received (not shown in FIG. 3), instead of a completed interference graph. Channel information 310 and interference graph 312 may represent inputs to channel assignment algorithm 314, which may implement various algorithms, procedures, methods, etc. for iterative fair channel assignment, as will be described in further detail with respect to FIG. 4. Then, as an output of channel assignment algorithm 314, channel assignment 316 may represent a coloring (i.e., channel population or assignment) of interference graph 312, such that the K wireless channels are assigned to the N wireless networks.

Turning now to FIG. 4, a block diagram of selected elements of an embodiment of method 400 for iterative fair channel assignment is shown in flow chart format. As noted above, method 400 may be used for locations where N wireless networks are assigned K wireless channels. Method 400 may be performed by management system 200 and may represent operations performed by iterative fair channel assignment 214 (see FIGS. 1 and 2). It is noted that certain operations depicted in method 400 may be rearranged or omitted, as desired.

Method 400 may begin by receiving interference graph G and initializing (operation 402) weight factor w_f=0 for all networks and channel count k=1. Interference graph G may represent an instance of interference graph 312 in FIG. 3. Then, method 400 may enter a loop that iterates over k from 1 to K and may make a decision whether k≦1 (operation 404). When the result of operation 404 is NO, method 400 end (operation 414). When the result of operation 404 is YES, channel k may be assigned (operation 406) to network u having minimum value for weight factor w_f, else channel k may be randomly assigned. Channel k may be randomly assigned when no networks having a minimum value for weight factor w_f are available, for example, when a plurality of networks are tied in values for weight factor w_f. Then, channel k may be assigned (operation 408) to as many networks as possible not interfering with network u while favoring networks with smaller weight factor w_f.

In one embodiment, a first algorithm for implementing operation 408 may apply a first definition to define Rᵤ as a set of all re-use networks for network u (i.e., all networks that do not share an edge and do not interfere with network u), and then assign channel k to all networks in Rᵤ. If applying the first definition is not possible (i.e., when at least two networks in Rᵤ share an edge), a second definition may be applied to define Sᵣᵤ as a subset of Rᵤ as set of networks having a minimum value for weight factor w_f, and then assign channel k to all networks in Sᵣᵤ. If applying the second definition is not possible (i.e., when at least two networks in Sᵣᵤ share an edge), Rₛ may be constructed from all possible pairs of non-interfering) networks in Rᵣᵤ with at least one network in Sᵣᵤ and then assign channel k to as many disjoint pairs of networks in Sᵣᵤ as possible. Two network pairs are disjoint when there is no edge between any of the four corresponding nodes in interference graph G. When two pairs are not disjoint (i.e., share at least one edge in interference graph G), channel k may be assigned to the pair of networks having a smaller sum value for weight factor w_f, otherwise a random choice may be made in case of a tie of the pairwise sum values for weight factor w_f. When Rₛ is empty (i.e., no re-use pairs of networks in Rᵤ), channel k may be randomly assigned to a network selected from Sᵣᵤ. A final check may be made whether channel k may be assigned to more networks from remaining networks in Rᵤ, again by first selecting networks with smaller values for weight factor w_f and breaking any ties in values for weight factor w_f with a random choice of networks. It is noted that the first algorithm may have a polynomial complexity given by O(KN⁴) but may be very efficient in terms of resource utilization (i.e., re-use of channels).

In another embodiment, a second algorithm for implementing operation 408 may apply a first definition to define Rᵤ as a set of all re-use networks for network u (i.e., all networks that do not share an edge and do not interfere with network u), and then assign channel k to all networks in Rᵤ. If applying the first definition is not possible (i.e., when at least two networks in Rᵤ share an edge), a second definition may be applied to define Sᵣᵤ as a subset of Rᵣ as a set of networks having a minimum value for w_f, and then assign channel k to all networks in Sᵣᵤ. If applying the second definition is not possible, (i.e., when at least two networks in Sᵣᵤ share an edge), channel k may be assigned to a network v randomly selected from Sᵣᵤ. Then, the sets Rᵤ and Sᵣᵤ may be updated by removing node v and neighbors nodes having an edge with node v from the graph G. This process of randomly selecting a node from Sᵣᵤ and updating the sets Rᵤ and Sᵣᵤ may be repeated until the set Sᵣᵤ is empty. When Sᵣᵤ is empty but Rᵤ is not empty, resource k may be assigned to a node z selected for having a minimum value of w_f (or randomly selected when no single node has a minimum value of w_f) from Rᵤ. Similarly, the set Rᵤ may be updated by removing node z and neighbors nodes having an edge with node z from the graph G. This process of randomly selecting a node from Rᵤ and updating the set Rᵤ may be repeated until the set Rᵤis empty. It is noted that the second algorithm may have a polynomial complexity given by O(KN²) but may be less efficient than the first algorithm in terms of resource utilization (i.e., re-use of channels).

With regard to the first and second algorithms for operation 408, it is noted that networks are primarily selected for assignment based on values of the weight factor w_f. When there are multiple options, a tie in values of the weight factor w_f may be broken based on node degree or simply by random selection. Breaking the ties based on maximum node degree may sacrifice spectrum utilization, because with a larger number of neighbors, the chances of re-use become smaller. On the other hand, breaking the ties based on a smaller node degree may result in larger spectrum utilization. However, the smaller node degree metric may trade off the fairness by giving (deterministic) priority to some networks. With random selection, every network has equal chance of getting the channel assignment, which, in turn, balances the fairness-utilization trade off.

Continuing with method 400, the channel assignments and interference graph may be updated (operation 410). In operation 410, the weight factor w_f may be updated for all networks, based on results of operation 408. Furthermore, certain networks may be removed from interference graph G, whose assigned number of channels has reached a maximum value based on a channel aggregation limit, for example, for a given type of wireless access technology. Then, the channel count k may be incremented (operation 412) and method 400 may loop back to operation 404.

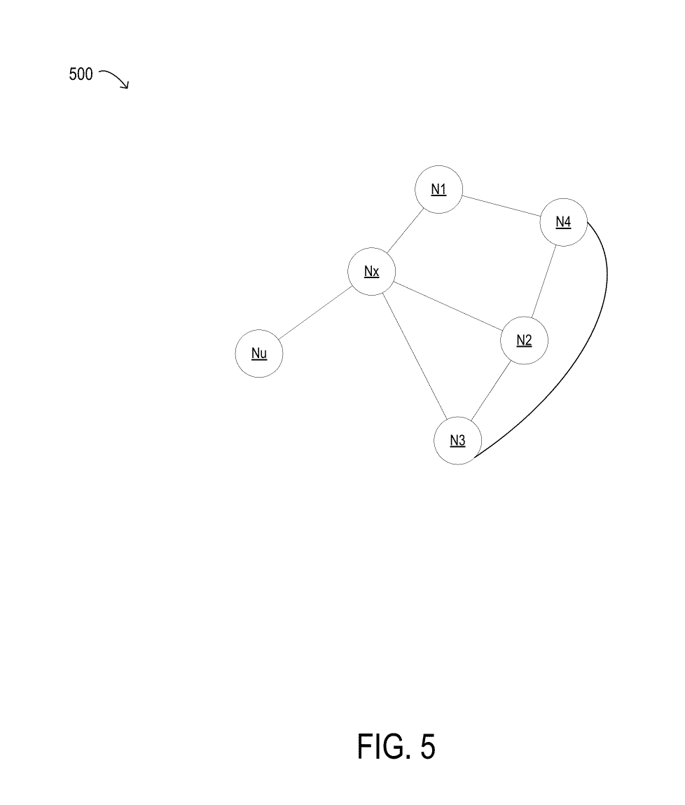

Turning now to FIG. 5, selected elements of an embodiment of interference graph 500 for iterative fair channel assignment are illustrated. As shown, interference graph 500 may depict an example of results of method 400 (see FIG. 4). In interference graph 500, re-use networks for network Nu may be networks N1, N2, N3, and N4, while network Nx is not a re-use network for network Nu. Accordingly, Ru {N1, N2, N3, N4} and the values for weight factor w_f for nodes in Rᵤ is given by the set {0, 0, 0, 0} in an exemplary embodiment. The set Sᵣᵤ of minimum values for w_f in Rᵤ is given by Sᵣᵤ={N1, N2, N3, N4}. Based on the first algorithm for operation 408, the re-use pairs of networks from Rᵤ with at least one network in Sᵣᵤ is given by the set R_{S} {(N1, N3)}. Then, channel k is assigned to networks N1 and N3, as well as network Nu. Based on the second algorithm for operation 408, channel k is assigned to a network randomly selected from Sᵣᵤ, e.g., network N4. The sets Rᵤ and Sᵣᵤ are then updated by removing N4 and all its neighbors (i.e., N1, N2, N3). Thus, sets Rᵤ and Sᵣᵤ become empty and channel k is not re-used in any other network.

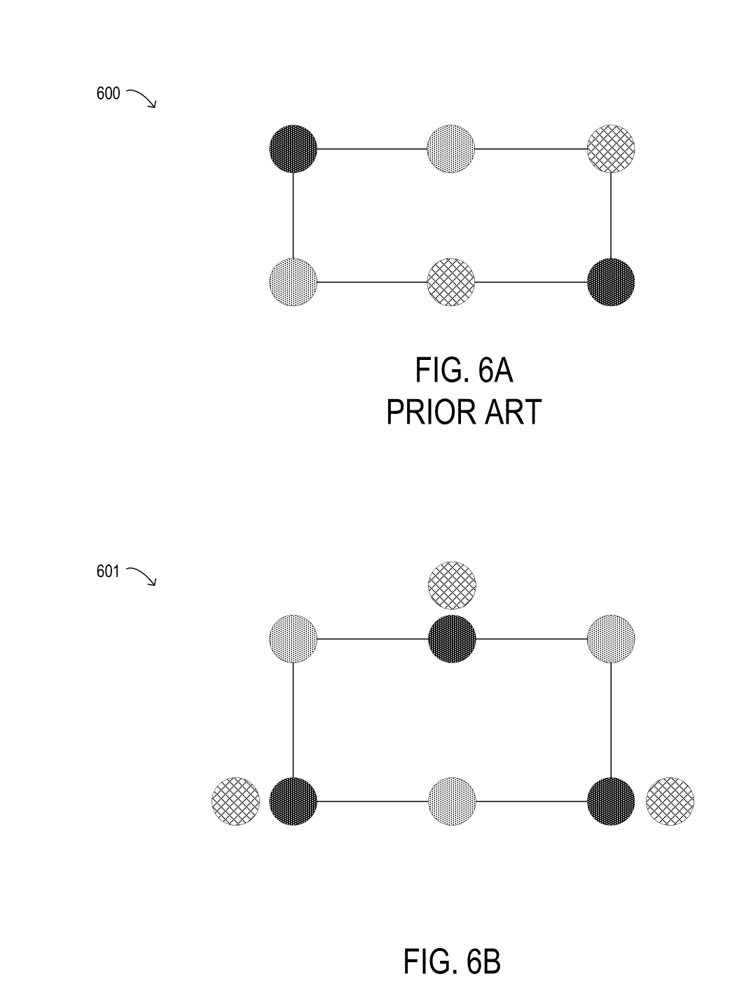

Turning now to FIGS. 6A and 6B, a diagram of selected elements of an embodiment of prior art colored interference graph 600 is shown in FIG. 6A, while a diagram of selected elements of an embodiment of interference graph 601 colored using an iterative fair channel assignment algorithm, as described herein, is shown in FIG. 6B. The graph node colorings are shown as black and white patterns representing colors (i.e., channel assignments to a node) in FIGS. 6A and 6B. Both prior art interference graph 600 in FIG. 6A and interference graph 601 in FIG. 6B show 6 network nodes assigned 3 channels. Comparing interference graph 601, whose coloring is applied using an iterative fair channel assignment algorithm to result in a bandwidth utilization of 9w, as described herein, with prior art interference graph 600 using a sequential graph coloring algorithm with ordering of the networks to result in a bandwidth utilization of 6w, it is evident that interference graph 601 may achieve 150% better utilization of the available channels. It is further noted that interference graph 601 may assign multiple channels to a given node, while balancing the spectrum allocation fairness across the networks.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for iterative fair channel assignment, comprising:
receiving channel information for K wireless channels available at a location, wherein K is greater than or equal to 1;
receiving network information for N wireless networks operating in the location, the network information determining interference between neighboring pairs of wireless networks in the N wireless networks, wherein N is an integer greater than or equal to 1;
for each of the K wireless channels, including a first wireless channel:
assigning the first wireless channel to a first wireless network selected from the N wireless networks, wherein the first wireless network is preferentially selected to have a minimum weight factor; and
assigning the first wireless channel to other wireless networks selected from the N wireless networks not interfering with the first wireless network, wherein the other wireless networks are preferentially selected to have minimum weight factors,
wherein a weight factor indicates a measure of fairness in assigning the K wireless channels to a wireless network, and wherein assigning the first wireless channel maintains orthogonality of wireless channels assigned to each of the neighboring pairs of wireless networks.

2. The method of claim 1, wherein the network information includes location information for the N wireless networks.

3. The method of claim 1, wherein the network information respectively indicates, for each of the N wireless networks, at least one of: a type of wireless access technology and a network load.

4. The method of claim 1, wherein assigning the first wireless channel to the first wireless network includes:
when a first plurality of wireless networks shares an identical minimum weight factor, randomly selecting the first wireless network from the first plurality of wireless networks.

5. The method of claim 1, wherein assigning the first wireless channel to the other wireless networks includes:
defining a set of wireless networks that do not interfere with the first wireless network; and
when all wireless networks in the set do not interfere with each other:
selecting each of the wireless networks in the set to pair with the first wireless network;
else, when at least some wireless networks in the set interfere with each other:
selecting, from the set, a second wireless network to pair with the first wireless network based on a minimum weight factor of the second wireless network.

6. The method of claim 5, wherein, when a second plurality of wireless networks in the set shares the minimum weight factor, assigning the first wireless channel to the other wireless networks includes:
when the second plurality of wireless networks do not interfere with each other:
selecting, from the set, each of the second plurality of wireless networks to pair with the first wireless network;
else, when at least some of the second plurality of wireless networks interfere with each other:
defining a set of re-use pairs of wireless networks for assigning to the first channel, wherein at least one of each re-use pair of wireless networks is included in the set of wireless networks; and
selecting a re-use pair of wireless networks from the set of re-use pairs of wireless networks based on a minimum weight factor summed over each re-use pair of wireless networks.

7. The method of claim 6, wherein, when a plurality of re-use pairs of wireless networks in the set of re-use pairs of wireless networks shares an identical minimum weight factor sum, selecting the re-use pair of wireless networks includes:
randomly selecting the re-use pair of wireless networks from the plurality of re-use pairs of wireless networks.

8. The method of claim 5, wherein, when a third plurality of wireless networks in the set of wireless networks shares the minimum weight factor, selecting, from the set, the second wireless network includes:
randomly selecting the second wireless network from the third plurality of wireless networks.

9. The method of claim 1, further comprising:
after assigning the first channel to a maximum number of wireless networks, updating the weight factor respectively for each of the N wireless networks; and
removing, from selection among the N wireless networks, wireless networks that have already been assigned a maximum number of channels.

10. An article of manufacture comprising:
a non-transitory, computer-readable medium; and
computer executable instructions stored on the computer-readable medium, the instructions readable by a processor and, when executed, for causing the processor to:
receive channel information for K wireless channels available at a location, wherein K is greater than or equal to 1;
receive network information for N wireless networks operating in the location, the network information determining interference between neighboring pairs of wireless networks in the N wireless networks, wherein N is an integer greater than or equal to 1;
for each of the K wireless channels, including a first wireless channel:
assign the first wireless channel to a first wireless network selected from the N wireless networks, wherein the first wireless network is preferentially selected to have a minimum weight factor; and
assign the first wireless channel to other wireless networks selected from the N wireless networks not interfering with the first wireless network, wherein the other wireless networks are preferentially selected to have minimum weight factors,
wherein a weight factor indicates a measure of fairness in assigning the K wireless channels to a wireless network, and wherein assigning the first wireless channel maintains orthogonality of wireless channels assigned to each of the neighboring pairs of wireless networks.

11. The article of manufacture of claim 10, wherein the network information includes location information for the N wireless networks.

12. The article of manufacture of claim 10, wherein the network information respectively indicates, for each of the N wireless networks, at least one of: a type of wireless access technology and a network load.

13. The article of manufacture of claim 10, wherein the instructions to assign the first wireless channel to the first wireless network include instructions to:
when a first plurality of wireless networks shares an identical minimum weight factor, randomly select the first wireless network from the first plurality of wireless networks.

14. The article of manufacture of claim 10, wherein the instructions to assign the first wireless channel to the other wireless networks include instructions to:
define a set of wireless networks that do not interfere with the first wireless network; and
when all wireless networks in the set do not interfere with each other:
select each of the wireless networks in the set to pair with the first wireless network;
else, when at least some wireless networks in the set interfere with each other:
select, from the set, a second wireless network to pair with the first wireless network based on a minimum weight factor of the second wireless network.

15. The article of manufacture of claim 14, wherein, when a second plurality of wireless networks in the set shares the minimum weight factor, the instructions to assign the first wireless channel to the other wireless networks include instructions to:
when the second plurality of wireless networks do not interfere with each other:
select, from the set, each of the second plurality of wireless networks to pair with the first wireless network;
else, when at least some of the second plurality of wireless networks interfere with each other:
define a set of re-use pairs of wireless networks for assigning to the first channel, wherein at least one of each re-use pair of wireless networks is included in the set of wireless networks; and
select a re-use pair of wireless networks from the set of re-use pairs of wireless networks based on a minimum weight factor summed over each re-use pair of wireless networks.

16. The article of manufacture of claim 15, wherein, when a plurality of re-use pairs of wireless networks in the set of re-use pairs of wireless networks shares an identical minimum weight factor sum, the instructions to select the re-use pair of wireless networks include instructions to:
randomly select the re-use pair of wireless networks from the plurality of re-use pairs of wireless networks.

17. The article of manufacture of claim 14, wherein, when a third plurality of wireless networks in the set of wireless networks shares the minimum weight factor, the instructions to select, from the set, the second wireless network include instructions to:
randomly select the second wireless network from the third plurality of wireless networks.

18. The article of manufacture of claim 10, further comprising instructions to:
after assigning the first channel to a maximum number of wireless networks, update the weight factor respectively for each of the N wireless networks; and
remove, from selection among the N wireless networks, wireless networks that have already been assigned a maximum number of channels.
